(19) United States
(12) Patent Application Publication
(10) Pub. No.: US 2019/0238030 A1
(43) Pub. Date: Aug. 1, 2019

(54) STATOR-COOLING STRUCTURE AND ROTARY ELECTRIC MACHINE

(71) Applicant: HONDA MOTOR CO., LTD., Tokyo (JP)

(72) Inventor: Shinji Kato, Wako-shi (JP)

(21) Appl. No.: 16/253,314

(22) Filed: Jan. 22, 2019

(30) Foreign Application Priority Data
Jan. 30, 2018 (JP) 2018-013608

(51) Int. Cl. H02K 9/20; H02K 1/20

(52) U.S. Cl. CPC H02K 9/20; H02K 1/20

(57) ABSTRACT

A stator-cooling structure of an embodiment includes: a rotor that is arranged on an inner side in a radial direction with respect to a stator having a tube shape; and an end surface plate that is provided on an end part in an axial direction of the rotor, wherein a diffusion slope surface that is sloped such that a refrigerant which is externally supplied is diffused outward in the radial direction using a rotation of the rotor is provided on an outer circumferential part of the end surface plate.

### CROSS-REFERENCE TO RELATED APPLICATION

Priority is claimed on Japanese Patent Application No. 2018-013608, filed on Jan. 30, 2018, the contents of which are incorporated herein by reference.

### BACKGROUND

### Field of the Invention

The present invention relates to a stator-cooling structure and a rotary electric machine.

### Background

In a rotary electric machine that is mounted on a hybrid automobile, an electric automobile, and the like, a magnetic field is formed on a stator core by supplying a current to a coil, and a magnetic attraction force or repulsion force occurs between the stator core and a permanent magnet of a rotor. Thereby, the rotor is rotated relative to the stator.

In the rotary electric machine described above, when heat is generated in association with driving, the generated heat may lead to degradation of performance. Therefore, a variety of configurations for cooling the rotary electric machine have been considered. For example, in Japanese Patent Application, Publication No. 2013-55775A, a configuration is disclosed which includes a rotor shaft having a refrigerant supply port capable of supplying a refrigerant from a refrigerant supply path inside the shaft to the outside of the shaft, and a rotor core having an inner circumferential part on which a refrigerant flow path capable of allowing the refrigerant that is supplied from the refrigerant supply port of the rotor shaft to flow in an axial direction is provided. In Japanese Patent Application, Publication No. 2013-55775A, a rotor and a stator coil are coolable by shaft center cooling.

On the other hand, a structure is also known which cools a rotary electric machine by dropping a refrigerant from a pipe that is provided on an outside in a radial direction of a stator.

### SUMMARY

However, when allowing the refrigerant to flow from the refrigerant supply path inside the rotor shaft toward the refrigerant flow path at the inner circumferential part of the rotor core, a structure that allows the flow of the refrigerant to branch is required, and an inner structure of the rotor may be complicated.

On the other hand, in the structure in which the refrigerant is dropped from the outside in the radial direction of the stator, temperature distribution in the circumferential direction of the stator may occur, and it may be impossible to uniformly cool the stator.

Therefore, there is room for improvement in uniformly cooling the stator by a simple structure.

An object of an aspect of the present invention is to provide a stator-cooling structure and a rotary electric machine capable of uniformly cooling a stator by a simple structure.

(1) A stator-cooling structure according to an aspect of the present invention includes: a rotor that is arranged on an inner side in a radial direction with respect to a stator having a tube shape; and an end surface plate that is provided on an end part in an axial direction of the rotor, wherein a diffusion slope surface that is sloped such that a refrigerant which is externally supplied is diffused outward in the radial direction using a rotation of the rotor is provided on at least a portion of an outer circumferential part of the end surface plate.

(2) In the above stator-cooling structure, the diffusion slope surface may be sloped such that a more upstream side in a rotation direction of the rotor is located at a more outward position in the radial direction when seen from the axial direction of the rotor.

(3) In the above stator-cooling structure, the diffusion slope surface may be a curved surface having an arc shape and forming a protrusion inward in the radial direction.

(4) In the above stator-cooling structure, the curved surface may have a larger curvature at a more upstream side in the rotation direction of the rotor.

(5) In the above stator-cooling structure, the diffusion slope surface may include a front end surface that is directed outward in the radial direction.

(6) In the above stator-cooling structure, a plurality of diffusion slope surfaces may be provided throughout the entire outer circumferential part of the end surface plate.

(7) In the above stator-cooling structure, the plurality of diffusion slope surfaces may be arranged at an equal interval along an outer circumference of the end surface plate.

(8) In the above stator-cooling structure, the diffusion slope surface may be provided on a protrusion that protrudes outward in the radial direction from the outer circumferential part of the end surface plate.

(9) In the above stator-cooling structure, the diffusion slope surface may be provided on a groove part that is hollowed inward in the radial direction from the outer circumferential part of the end surface plate.

(10) A rotary electric machine according to another aspect of the present invention includes: a stator; and the stator-cooling structure described above.

According to the above configuration (1), the diffusion slope surface that is sloped such that the refrigerant which is externally supplied is diffused outward in the radial direction using the rotation of the rotor is provided on at least a portion of the outer circumferential part of the end surface plate, and thereby, the refrigerant is diffused outward in the radial direction by the rotation of the rotor. Therefore, it is possible to supply the refrigerant uniformly in the circumferential direction on an inner circumferential part of the stator without complicating an inner structure (inner structures of a rotor shaft and a rotor core) of the rotor. Accordingly, it is possible to uniformly cool the stator by a simple structure.

According to the above configuration (2), the diffusion slope surface is sloped such that the more upstream side in the rotation direction of the rotor is located at the more outward position in the radial direction when seen from the axial direction of the rotor, and thereby, the refrigerant flows along the diffusion slope surface by the rotation of the rotor. Therefore, it is possible to further smoothly diffuse the refrigerant.

According to the above configuration (3), the diffusion slope surface is the curved surface having an arc shape and forming a protrusion inward in the radial direction, and thereby, it is possible to further smoothly diffuse the refrigerant compared to a case where the diffusion slope surface is a flat surface.

According to the above configuration (4), the curved surface has a larger curvature at the more upstream side in the rotation direction of the rotor, and thereby, it is possible to further smoothly diffuse the refrigerant compared to a case where the curvature of the curved surface is constant.

According to the above configuration (5), the diffusion slope surface includes the front end surface that is directed outward in the radial direction, and thereby, it is possible to diffuse the refrigerant outward in the radial direction along the front end surface.

According to the above configuration (6), the plurality of diffusion slope surfaces are provided throughout the entire outer circumferential part of the end surface plate, and thereby, it is possible to supply the refrigerant further uniformly on the inner circumferential part of the stator compared to a case where the diffusion slope surface is provided locally on the outer circumferential part of the end surface plate.

According to the above configuration (7), the plurality of diffusion slope surfaces are arranged at an equal interval along the outer circumference of the end surface plate, and thereby, it is possible to supply the refrigerant further uniformly on the inner circumferential part of the stator compared to a case where the plurality of diffusion slope surfaces are arranged randomly along the outer circumference of the end surface plate.

According to the above configuration (8), the diffusion slope surface is provided on the protrusion that protrudes outward in the radial direction from the outer circumferential part of the end surface plate, and thereby, it is possible to diffuse the refrigerant by using the diffusion slope surface of the protrusion.

According to the above configuration (9), the diffusion slope surface is provided on the groove part that is hollowed inward in the radial direction from the outer circumferential part of the end surface plate, and thereby, it is possible to diffuse the refrigerant by using the diffusion slope surface of the groove part.

According to the above configuration (10), by including the stator and the stator-cooling structure described above, it is possible to provide a rotary electric machine capable of uniformly cooling the stator by a simple structure.

### BRIEF DESCRIPTION OF THE DRAWINGS

FIG. 1 is a schematic configuration view of a rotary electric machine according to an embodiment.

FIG. 2 is a schematic perspective view of the rotary electric machine according to the embodiment.

FIG. 3 is a view seen from an outside in an axial direction of an end surface plate according to the embodiment.

FIG. 4 is an enlarged view of a main part of FIG. 3.

FIG. 5 is a view showing an operation of a diffusion slope surface according to the embodiment.

FIG. 6 is a view showing an operation of a diffusion slope surface according to a first modified example of the embodiment.

FIG. 7 is a view showing an operation of a diffusion slope surface according to a second modified example of the embodiment.

FIG. 8 is an enlarged view of a main part of an end surface plate according to a third modified example of the embodiment.

FIG. 9 is an enlarged view of a main part of an end surface plate according to a fourth modified example of the embodiment.

FIG. 10 is a view seen from an outside in an axial direction of an end surface plate according to a fifth modified example of the embodiment.

### DESCRIPTION OF THE EMBODIMENTS

Hereinafter, embodiments of the present invention will be described with reference to the drawings. The embodiment is described using an example of a rotary electric machine (travel motor) that is mounted on a vehicle such as a hybrid automobile and an electric automobile.

### <Rotary Electric Machine>

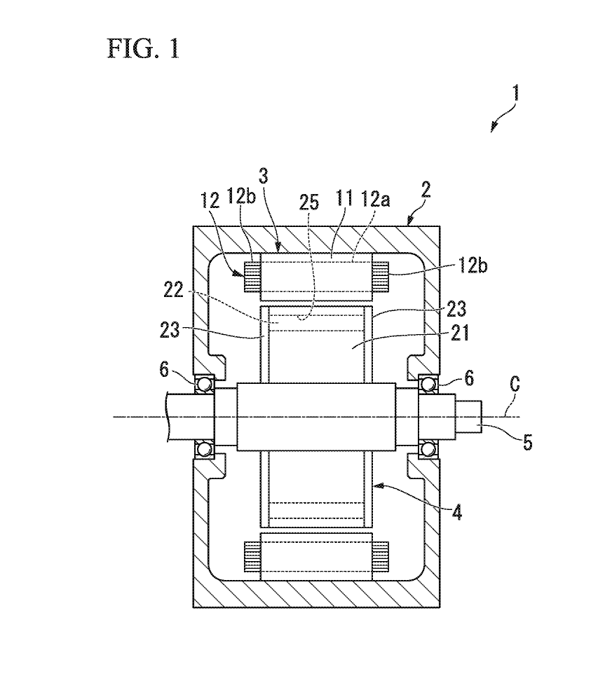

FIG. 1 is a schematic configuration view showing an entire configuration of a rotary electric machine 1 according to the embodiment. FIG. 1 is a view that includes a cross-section cut by a virtual plane including an axis line C.

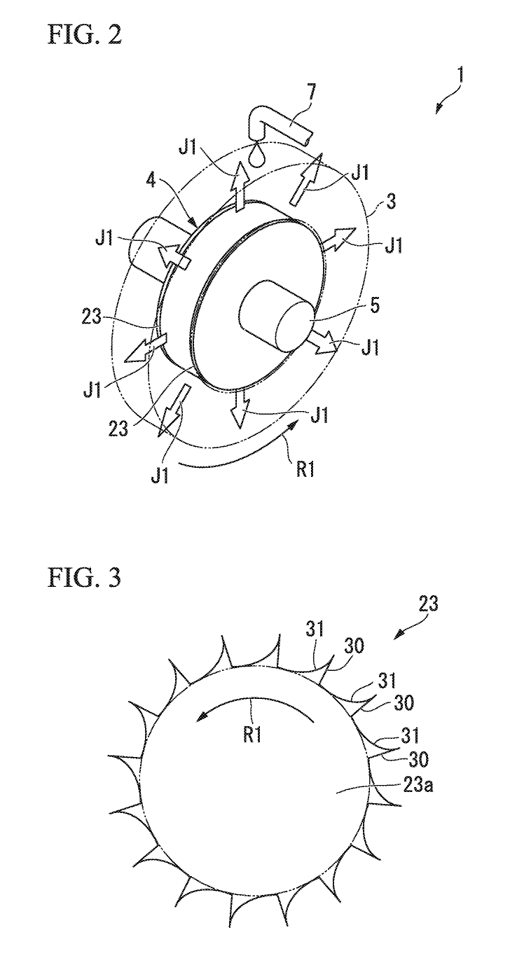

As shown in FIG. 1, the rotary electric machine 1 includes a case 2, a stator 3, a rotor 4, an output shaft 5, and a refrigerant supply mechanism 7 (refer to FIG. 2).

The case 2 forms a tubular box shape that accommodates the stator 3 and the rotor 4. A refrigerant (not shown) is accommodated inside the case 2. Part of the stator 3 is arranged in a state of being immersed in the refrigerant inside the case 2. For example, an ATF (Automatic Transmission Fluid), which is an operating oil that is used for power transmission, lubrication of a transmission and the like, or the like is used as the refrigerant.

The output shaft 5 is supported rotatably by the case 2. In FIG. 1, a bearing 6 rotatably supports the output shaft 5. Hereinafter, a direction along the axis line C of the output shaft 5 is referred to as an “axial direction”, a direction perpendicular to the axis line C is referred to as a “radial direction”, and a direction around the axis line C is referred to as a “circumferential direction”.

The stator 3 includes a stator core 11 and a coil 12 that is provided on the stator core 11.

The stator core 11 forms a tube shape that is arranged concentrically with the axis line C. The stator core 11 is fixed to an inner circumferential surface of the case 2. For example, electromagnetic steel sheets are laminated in the axial direction and constitute the stator core 11. The stator core 11 may be a so-called dust core formed by compressively molding a metal magnetic powder.

The coil 12 is provided on the stator core 11. The coil 12 includes a U-phase coil, a V-phase coil, and a W-phase coil that are arranged to have a phase difference of 120° from one another with respect to the circumferential direction. The coil 12 includes an insertion part 12a that is inserted through a slot (not shown) of the stator core 11 and a coil end part 12b that protrudes in the axial direction from the stator core 11. A current flows through the coil 12, and thereby, a magnetic field is generated at the stator core 11.

The rotor 4 is arranged on an inside in the radial direction with respect to the stator 3 so as to be spaced from the stator 3. The rotor 4 is fixed to the output shaft 5. The rotor 4 is formed to be integrally rotatable with the output shaft 5 around the axis line C. The rotor 4 includes a rotor core 21, a magnet 22, and an end surface plate 23. In the embodiment, the magnet 22 is a permanent magnet.

The rotor core 21 forms a tube shape that is arranged concentrically with the axis line C. The output shaft 5 is fixed by press fitting to the inside in the radial direction of the rotor core 21. Similarly to the stator core 11, the rotor core 21 may be formed by laminating electromagnetic steel sheets in the axial direction or may be a dust core.

A magnet support hole 25 that penetrates in the axial direction through the rotor core 21 is provided on an outer circumferential part of the rotor core 21. A plurality of magnet support holes 25 are arranged to be spaced in the circumferential direction. The magnet 22 is inserted in each of the magnet support holes 25.

A flow path (rotor inner flow path, not shown) that penetrates in the axial direction through the rotor core 21 is formed on an inner circumferential part of the rotor core 21.

The end surface plate 23 is arranged at both end parts in the axial direction of the rotor core 21. The output shaft 5 is fixed by press fitting to the inside in the radial direction of the end surface plate 23. The end surface plate 23 covers at least the magnet support hole 25 in the rotor core 21 from both end sides in the axial direction. The end surface plate 23 is in contact with an outer end surface in the axial direction of the rotor core 21.

### <Diffusion Slope Surface>

As shown in FIG. 3, a diffusion slope surface 31 that is sloped such that a refrigerant which is supplied by a refrigerant supply mechanism 7 (refer to FIG. 2) is diffused outward in the radial direction using the rotation of the rotor 4 is provided on an outer circumferential part of the end surface plate 23. In the embodiment, the diffusion slope surface 31 is provided on each of the pair of end surface plates 23 (refer to FIG. 2) that is located at each of both end parts in the axial direction of the rotor 4.

FIG. 2 is a perspective view showing a state in which a refrigerant that is dropped on the outer circumferential part of the end surface plate 23 is diffused outward in the radial direction by the rotation of the rotor 4. In FIG. 2, an arrow R1 indicates a rotation direction of the rotor 4, and an arrow J1 indicates a diffusion direction of the refrigerant. In FIG. 2, the diffusion slope surface 31 (refer to FIG. 3) and the like are not shown in the figure.

As shown in FIG. 3, a plurality of diffusion slope surfaces 31 are provided throughout the entire outer circumferential part of the end surface plate 23. The plurality of diffusion slope surfaces 31 are arranged at an equal interval along the outer circumference of the end surface plate 23.

The diffusion slope surface 31 is provided on a protrusion 30 that protrudes outward in the radial direction from the outer circumferential part of the end surface plate 23. For example, a plurality of protrusions 30 having the diffusion slope surface 31 are provided along an outer circumferential surface of an end surface plate main body 23a having a circular plate shape, and thereby, it is possible to manufacture the end surface plate 23 of the embodiment. In FIG. 3, an arrow R1 indicates a rotation direction of the rotor 4.

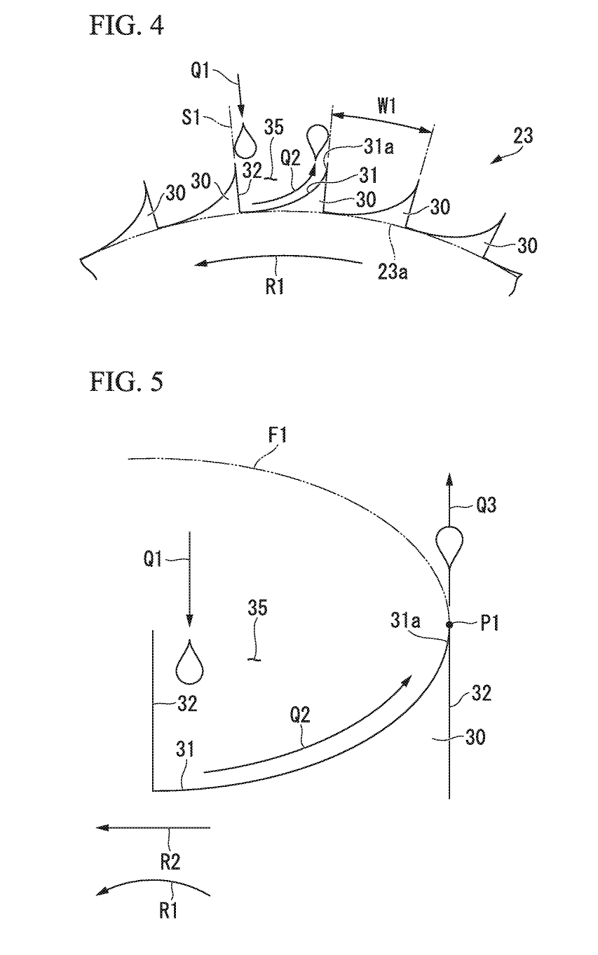

The diffusion slope surface 31 is sloped such that a more upstream side in the rotation direction R1 of the rotor 4 is located at a more outward position in the radial direction when seen from the axial direction of the rotor 4 shown in FIG. 4. That is, the diffusion slope surface 31 is sloped such that the more upstream side in the rotation direction R1 of the rotor 4 is located at the more outward position in the radial direction with respect to an imaginary plane S1 that includes the axis line C (refer to FIG. 1) and a line perpendicular to the axis line C. In FIG. 4, an arrow R1 indicates a rotation direction of the rotor 4, an arrow Q1 indicates a flow-in direction of the refrigerant that is supplied to the diffusion slope surface 31, and an arrow Q2 indicates a flow direction of the refrigerant along the diffusion slope surface 31.

The diffusion slope surface 31 is a curved surface having an arc shape and forming a protrusion inward in the radial direction. The curved surface has a larger curvature at a more upstream side in the rotation direction R1 of the rotor 4. The diffusion slope surface 31 includes a front end surface 31a that is directed outward in the radial direction at an upstream end in the rotation direction R1 of the rotor 4.

In FIG. 4, an example is shown in which five protrusions 30 are arranged at a constant interval on a portion (specifically, a portion of the outer circumferential surface of the end surface plate main body 23a forming an arc shape) of the outer circumferential part of the end surface plate 23 when seen from the axial direction of the rotor 4. In FIG. 4, a reference sign W1 indicates a spacing (hereinafter, also referred to as a “spacing of the protrusion 30”) between the diffusion slope surfaces 31. The spacing of the protrusion 30 means a distance between front ends (front end surfaces 31a of the diffusion slope surfaces 31) of two protrusions 30 that are adjacent in the rotation direction R1 of the rotor 4. In the embodiment, it is possible to rebound the refrigerant by the spacing W1 of the protrusion 30 shown in FIG. 4.

The protrusion 30 forms a sharp shape that protrudes outward in the radial direction such that a more upstream side in the rotation direction R1 of the rotor 4 is further sharpened when seen from the axial direction of the rotor 4. A front end part (sharp part) of the protrusion 30 is directed toward an inner circumferential surface of the stator 3 (refer to FIG. 2). Thereby, it is possible to diffuse the refrigerant to the inner circumferential surface side of the stator 3.

A second wall 32 that directs the refrigerant which is dropped on the outer circumferential part of the end surface plate 23 toward the diffusion slope surface 31 of the protrusion 30 is provided on the end surface plate 23. When seen from the axial direction of the rotor 4, the second wall 32 extends linearly outward in the radial direction from an outer end in the radial direction of the end surface plate main body 23a. That is, when seen from the axial direction of the rotor 4, the second wall 32 forms a flat surface shape along the radial direction. The second wall 32 forms a space 35 in which the refrigerant is dropped together with the diffusion slope surface 31.

In FIG. 5, an example is shown in which the diffusion slope surface 31 is arranged along part of an imaginary arc F1 that forms an ellipsoidal arc shape when seen from the axial direction of the rotor 4. The imaginary arc F1 is an ellipsoidal arc on a long axis side of an ellipse having a tangential direction component R2 in the rotation direction R1 of the rotor 4 as the long axis. A long axis end P1 of the imaginary arc F1 has an imaginary line perpendicular to the axis line as a tangential line.

In FIG. 5, an upstream end (front end of the diffusion slope surface 31) of the diffusion slope surface 31 in the rotation direction of the rotor 4 is located at the long axis end P1 of the imaginary arc F1. In the embodiment, it is possible to rebound the refrigerant in the tangential direction at the long axis end P1 of the imaginary arc F1 shown in FIG. 5. In FIG. 5, an arrow Q1 indicates a flow-in direction of the refrigerant that is supplied to the diffusion slope surface 31, an arrow Q2 indicates a flow direction of the refrigerant along the diffusion slope surface 31, and an arrow Q3 indicates a direction (tangential direction of the imaginary arc F1) in which the refrigerant is rebounded.

### <Operation>

Hereinafter, an operation of the diffusion slope surface 31 of the embodiment is described with reference to FIG. 5.

In the embodiment, by the diffusion slope surface 31 being a curved surface having an arc shape and forming a protrusion inward in the radial direction, the refrigerant flows along the curved surface by the rotation of the rotor 4, and therefore, a possibility in which the refrigerant is rebounded in an unintended direction by a centrifugal force associated with the rotation of the rotor 4 is low.

Specifically, in the embodiment, the protrusion 30 includes the second wall 32 (flat surface along the radial direction) that extends linearly outward in the radial direction from the outer end in the radial direction of the end surface plate main body 23a, and thereby, it is possible to direct the refrigerant along the second wall 32 toward the base end side (opposite side of the front end) of the diffusion slope surface 31. That is, in the embodiment, since a part which the refrigerant first enters between two protrusions 30 (space 35) that are adjacent in the rotation direction R1 of the rotor 4 is a flat surface along the radial direction, there is no part that blocks the refrigerant, and it is possible to smoothly direct the refrigerant to the base end side of the diffusion slope surface 31.

Additionally, in the embodiment, by the diffusion slope surface 31 being a curved surface having an arc shape and forming a protrusion inward in the radial direction such that the more upstream side in the rotation direction R1 of the rotor 4 is located at the more outward position in the radial direction from the inner end in the radial direction of the second wall 32, it is possible to allow the refrigerant that is introduced to the base end side of the diffusion slope surface 31 via the second wall 32 to flow along the curved surface, and therefore, it is possible to prevent the refrigerant from being rebounded in an unintended direction by a centrifugal force associated with the rotation of the rotor 4.

Additionally, in the embodiment, the curved surface has a larger curvature at the more upstream side in the rotation direction R1 of the rotor 4, and thereby, it is possible to allow the refrigerant that flows along the curved surface to flow smoothly toward the front end part (front end surface 31a of the diffusion slope surface 31) of the protrusion 30. Therefore, in the embodiment, it is possible to diffuse the refrigerant to the inner circumferential surface side of the stator 3 (refer to FIG. 2) from the front end part of the protrusion 30.

As described above, the stator-cooling structure of the above embodiment includes: the rotor 4 that is arranged on the inner side in the radial direction with respect to the stator 3 having a tube shape; and the end surface plate 23 that is provided on the end part in the axial direction of the rotor 4, wherein the diffusion slope surface 31 that is sloped such that the refrigerant which is externally supplied is diffused outward in the radial direction using the rotation of the rotor 4 is provided on the outer circumferential part of the end surface plate 23.

According to this configuration, the diffusion slope surface 31 that is sloped such that the refrigerant which is externally supplied is diffused outward in the radial direction using the rotation of the rotor 4 is provided on the outer circumferential part of the end surface plate 23, and thereby, the refrigerant is diffused outward in the radial direction by the rotation of the rotor 4. Therefore, it is possible to supply the refrigerant uniformly in the circumferential direction on the inner circumferential part of the stator 3 without complicating the inner structure (inner structures of the output shaft 5 and the rotor core 21) of the rotor 4. Accordingly, it is possible to uniformly cool the stator 3 by a simple structure.

In the above embodiment, the diffusion slope surface 31 is sloped such that the more upstream side in the rotation direction R1 of the rotor 4 is located at the more outward position in the radial direction when seen from the axial direction of the rotor 4, and thereby, the refrigerant flows along the diffusion slope surface 31 by the rotation of the rotor 4. Therefore, it is possible to further smoothly diffuse the refrigerant.

In the above embodiment, the diffusion slope surface 31 is the curved surface having an arc shape and forming a protrusion inward in the radial direction, and thereby, it is possible to further smoothly diffuse the refrigerant compared to a case where the diffusion slope surface 31 is a flat surface.

In the above embodiment, the curved surface has a larger curvature at the more upstream side in the rotation direction R1 of the rotor 4, and thereby, it is possible to further smoothly diffuse the refrigerant compared to a case where the curvature of the curved surface is constant.

In the above embodiment, the diffusion slope surface 31 includes the front end surface 31a that is directed outward in the radial direction, and thereby, it is possible to diffuse the refrigerant outward in the radial direction along the front end surface 31a.

In the above embodiment, the plurality of diffusion slope surfaces 31 are provided throughout the entire outer circumferential part of the end surface plate 23, and thereby, it is possible to supply the refrigerant further uniformly on the inner circumferential part of the stator 3 compared to a case where the diffusion slope surface 31 is provided locally on the outer circumferential part of the end surface plate 23.

In the above embodiment, the plurality of diffusion slope surfaces 31 are arranged at an equal interval along the outer circumference of the end surface plate 23, and thereby, it is possible to supply the refrigerant further uniformly on the inner circumferential part of the stator 3 compared to a case where the plurality of diffusion slope surfaces 31 are arranged randomly along the outer circumference of the end surface plate 23.

In the above embodiment, the diffusion slope surface 31 is provided on the protrusion 30 that protrudes outward in the radial direction from the outer circumferential part of the end surface plate 23, and thereby, it is possible to diffuse the refrigerant by using the diffusion slope surface 31 of the protrusion 30.

The rotary electric machine 1 of the above embodiment includes the stator 3 and the stator-cooling structure described above, and thereby, it is possible to provide the rotary electric machine 1 capable of uniformly cooling the stator 3 by a simple structure.

Hereinafter, modified examples of the embodiment are described. In each of modified examples, the same reference numerals are given to the same configurations as the embodiment, and detailed description of the configurations is omitted.

### FIRST MODIFIED EXAMPLE

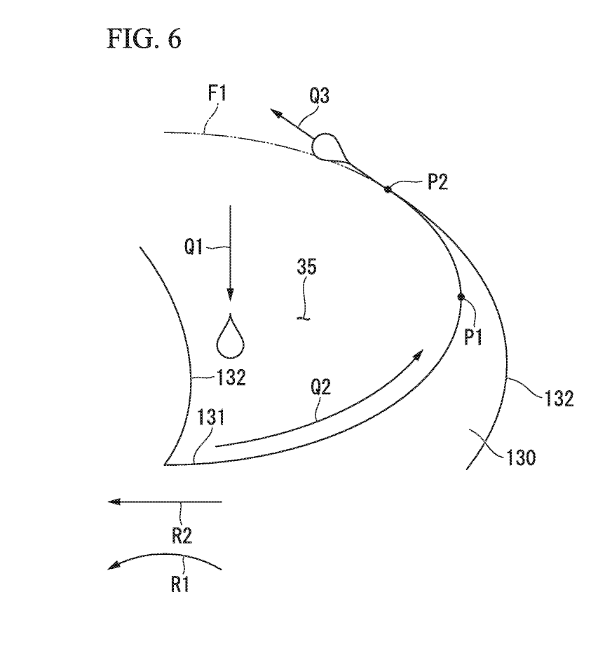

In the embodiment described above, a configuration in which the upstream end (front end of the diffusion slope surface 31) of the diffusion slope surface 31 in the rotation direction R1 of the rotor 4 is located at the long axis end P1 of the imaginary arc F1 is described; however, the embodiment is not limited thereto. For example, as shown in FIG. 6, a front end of a diffusion slope surface 131 may be located at a short axis end side of the imaginary arc F1. FIG. 6 shows an example in which the front end of the diffusion slope surface 131 is arranged at a short axis end side position P2 which is a more outward position in the radial direction than the long axis end P1 of the imaginary arc F1 when seen from the axial direction of the rotor 4.

When seen from the axial direction of the rotor 4, the protrusion 130 of a first modified example forms a sharp shape that protrudes outward in the radial direction such that a more upstream side in the rotation direction R1 of the rotor 4 extends more outward in the radial direction, then the protrusion 130 is curved toward the downstream side in the rotation direction R1 of the rotor 4, and the more downstream side in the rotation direction R1 of the rotor 4 is sharpened.

In FIG. 6, a second wall 132 forms an arc shape when seen from the axial direction and forms, together with the diffusion slope surface 131, a space 35 in which the refrigerant is dropped. In FIG. 6, an arrow Q1 indicates a flow-in direction of the refrigerant that is supplied to the diffusion slope surface 131, an arrow Q2 indicates a flow direction of the refrigerant along the diffusion slope surface 131, and an arrow Q3 indicates a direction (tangential direction of the imaginary arc F1) in which the refrigerant is rebounded.

In the first modified example, the front end of the diffusion slope surface 131 is located on a short axis end side at a more outward position in the radial direction than the long axis end P1 of the imaginary arc F1 when seen from the axial direction of the rotor 4, and thereby, it is possible to diffuse the refrigerant to a position close to a position on which the refrigerant is dropped compared to the case of FIG. 5.

### SECOND MODIFIED EXAMPLE

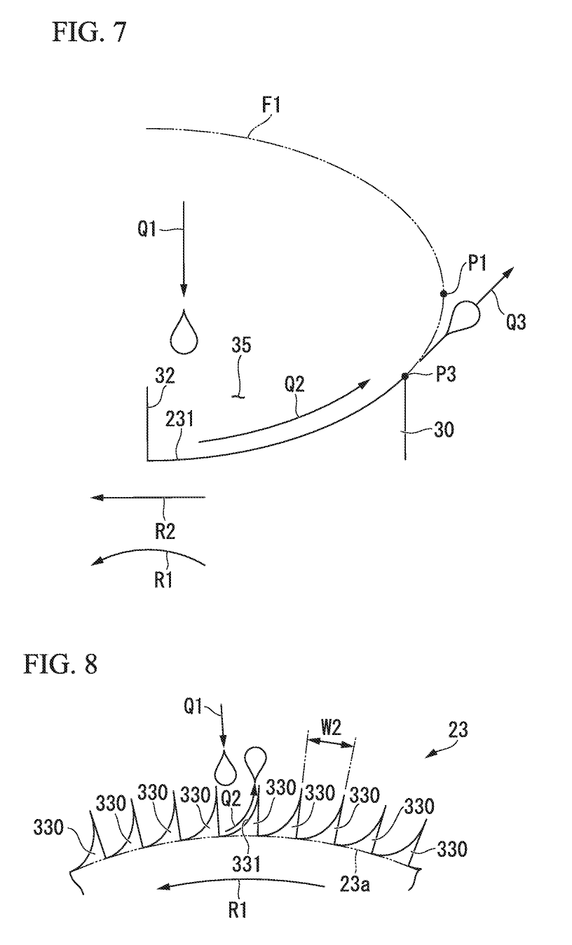

In the first modified example described above, a configuration is described in which the front end of the diffusion slope surface 131 is arranged at the short axis end side position P2 which is a more outward position in the radial direction than the long axis end P1 of the imaginary arc F1 when seen from the axial direction of the rotor 4; however, the embodiment is not limited thereto. For example, as shown in FIG. 7, the front end of the diffusion slope surface 231 may be arranged at a short axis end side position P3 which is a more inward position in the radial direction than the long axis end P1 of the imaginary arc F1 when seen from the axial direction of the rotor 4.

In FIG. 7, an arrow Q1 indicates a flow-in direction of the refrigerant that is supplied to the diffusion slope surface 231, an arrow Q2 indicates a flow direction of the refrigerant along the diffusion slope surface 231, and an arrow Q3 indicates a direction (tangential direction of the imaginary arc F1) in which the refrigerant is rebounded.

In the second modified example, the front end of the diffusion slope surface 231 is located on a short axis end side position at a more inward position in the radial direction than the long axis end P1 of the imaginary arc F1 when seen from the axial direction of the rotor 4, and thereby, it is possible to diffuse the refrigerant to a position far from a position on which the refrigerant is dropped compared to the case of FIG. 5.

As shown in FIG. 5 to FIG. 7, by changing the shape (shape of the diffusion slope surface) of the protrusion, it is possible to adjust the position to which the refrigerant is diffused.

### THIRD MODIFIED EXAMPLE

In the embodiment described above, the configuration (refer to FIG. 4) in which five protrusions 30 are arranged at a constant interval on the portion (specifically, the portion of the outer circumferential surface of the end surface plate main body 23a forming an arc shape) of the outer circumferential part of the end surface plate 23 when seen from the axial direction of the rotor 4 is described; however, the embodiment is not limited thereto. For example, as shown in FIG. 8, a spacing W2 of a protrusion 330 may be narrower than the spacing W1 of the protrusion 30 of FIG. 4 (W2<W1).

In FIG. 8, an example is shown in which nine protrusions 330 are arranged at a constant interval on a portion of an outer circumferential part of the end surface plate 23 when seen from the axial direction of the rotor 4. In FIG. 8, an arrow R1 indicates a rotation direction R1 of the rotor 4, an arrow Q1 indicates a flow-in direction of the refrigerant that is supplied to the diffusion slope surface 331, and an arrow Q2 indicates a flow direction of the refrigerant along the diffusion slope surface 331.

In the third modified example, the spacing W2 of the protrusion 330 is narrower compared to the case of FIG. 4 when seen from the axial direction of the rotor 4, and thereby, it is possible to shorten a period of time from when the refrigerant is dropped on the diffusion slope surface 331 to when the refrigerant is diffused. Additionally, it is possible to diffuse the refrigerant to a position closer to a position on which the refrigerant is dropped compared to the case of FIG. 4.

### FOURTH MODIFIED EXAMPLE

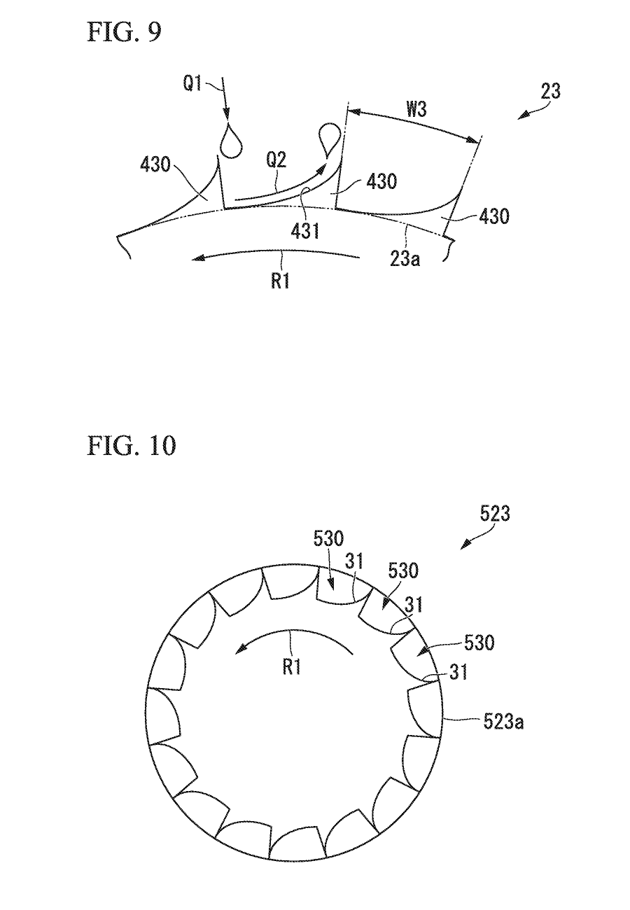

In the third modified example described above, a configuration in which the spacing W2 of the protrusion 330 is narrower compared to the case of FIG. 4 when seen from the axial direction of the rotor 4 is described; however, the modified example is not limited thereto. For example, as shown in FIG. 9, a spacing W3 of a protrusion 430 may be wider than the spacing W1 of the protrusion 30 of FIG. 4 (W3>W1).

In FIG. 9, an example is shown in which three protrusions 430 are arranged at a constant interval on a portion of an outer circumferential part of the end surface plate 23 when seen from the axial direction of the rotor 4. In FIG. 9, an arrow R1 indicates a rotation direction R1 of the rotor 4, an arrow Q1 indicates a flow-in direction of the refrigerant that is supplied to the diffusion slope surface 431, and an arrow Q2 indicates a flow direction of the refrigerant along the diffusion slope surface 431.

In the fourth modified example, the spacing W3 of the protrusion 430 is wider compared to the case of FIG. 4 when seen from the axial direction of the rotor 4, and thereby, it is possible to lengthen a period of time from when the refrigerant is dropped on the diffusion slope surface 431 to when the refrigerant is diffused. Additionally, it is possible to diffuse the refrigerant to a position that is farther from a position on which the refrigerant is dropped compared to the case of FIG. 4.

As shown in FIG. 4, FIG. 8, and FIG. 9, by changing the spacing (spacing of the diffusion slope surface) of the protrusion, it is possible to adjust the period of time from when the refrigerant is dropped on the diffusion slope surface to when the refrigerant is diffused and the position to which the refrigerant is diffused.

### FIFTH MODIFIED EXAMPLE

In the embodiment described above, the configuration (refer to FIG. 3) in which the diffusion slope surface 31 is provided on the protrusion 30 that protrudes outward in the radial direction from the outer circumferential part of the end surface plate 23 is described; however, the embodiment is not limited thereto. For example, as shown in FIG. 10, the diffusion slope surface 31 may be provided on a groove part 530 that is hollowed inward in a radial direction from an outer circumferential part of an end surface plate 523. For example, by forming a plurality of groove parts 530 having the diffusion slope surface 31 along an outer circumferential surface of an end surface plate main body 523a (base material) having a circular plate shape, it is possible to manufacture the end surface plate 523 of the fifth modified example. In FIG. 10, an arrow R1 indicates a rotation direction of the rotor 4. The groove part 530 may be provided on a portion in the axial direction of the outer circumferential part of the end surface plate 523 or may be provided on the whole in the axial direction of the outer circumferential part of the end surface plate 523.

In the fifth modified example, the diffusion slope surface 31 is provided on the groove part 530 that is hollowed inward in the radial direction from the outer circumferential part of the end surface plate 523, and thereby, it is possible to diffuse the refrigerant by using the diffusion slope surface 31 of the groove part 530.

### OTHER MODIFIED EXAMPLES

The above embodiment is described using an example in which the rotary electric machine 1 is a travel motor that is mounted on a vehicle such as a hybrid automobile and an electric automobile; however, the embodiment is not limited thereto. For example, the rotary electric machine 1 may be a motor for power generation, a motor for other applications, or a rotary electric machine (including a dynamo) for applications other than a vehicle.

The above embodiment is described using an example in which the refrigerant is supplied to the inner circumferential part of the stator 3 according to the operation of the diffusion slope surface 31 that is provided on the outer circumferential part of the end surface plate 23 by the rotation of the rotor 4; however, the embodiment is not limited thereto. For example, shaft center cooling may be further performed using a shaft flow path that is provided on the output shaft 5. For example, the refrigerant may be supplied toward the diffusion slope surface 31 of the end surface plate 23 via a supply port that is provided on the case 2 or the like.

The above embodiment is described using an example in which the diffusion slope surface 31 is provided on each of the pair of end surface plates 23 that is located at each of both end parts in the axial direction of the rotor 4; however, the embodiment is not limited thereto. For example, the diffusion slope surface 31 may be provided on only one end surface plate 23 that is located at one of end parts in the axial direction of the rotor 4.

The above embodiment is described using an example in which the diffusion slope surface 31 is the curved surface having an arc shape and forming a protrusion inward in the radial direction; however, the embodiment is not limited thereto. For example, the diffusion slope surface 31 may include a flat surface that is sloped linearly such that a more upstream side in a rotation direction of the rotor 4 is located at a more outward position in a radial direction when seen from an axial direction of the rotor 4.

The above embodiment is described using an example in which the curved surface in the diffusion slope surface 31 has a larger curvature at the more upstream side in the rotation direction R1 of the rotor 4; however, the embodiment is not limited thereto. For example, the curved surface in the diffusion slope surface 31 may have a smaller curvature at the more upstream side in the rotation direction R1 of the rotor 4.

The above embodiment is described using an example in which a plurality of diffusion slope surfaces 31 are provided throughout the entire outer circumferential part of the end surface plate 23; however, the embodiment is not limited thereto. For example, the diffusion slope surface 31 may be provided locally on the outer circumferential part of the end surface plate 23. For example, only one diffusion slope surface 31 may be provided on the outer circumferential part of the end surface plate 23. That is, the diffusion slope surface 31 may be provided on at least a portion of the outer circumferential part of the end surface plate 23.

The above embodiment is described using an example in which a plurality of diffusion slope surfaces 31 are arranged at an equal interval along the outer circumference of the end surface plate 23; however, the embodiment is not limited thereto. For example, the plurality of diffusion slope surfaces 31 may be arranged at an irregular interval along the outer circumference of the end surface plate 23. For example, the plurality of diffusion slope surfaces 31 may be arranged randomly along the outer circumference of the end surface plate 23.

Although the embodiments of the invention have been described, the present invention is not limited to the embodiments described above. Addition, omission, substitution, and a variety of changes of the configurations can be made without departing from the scope of the invention, and modified examples described above can be appropriately combined.

What is claimed is:

1. A stator-cooling structure, comprising:
a rotor that is arranged on an inner side in a radial direction with respect to a stator having a tube shape; and
an end surface plate that is provided on an end part in an axial direction of the rotor,
wherein a diffusion slope surface that is sloped such that a refrigerant which is externally supplied is diffused outward in the radial direction using a rotation of the rotor is provided on at least a portion of an outer circumferential part of the end surface plate.

2. The stator-cooling structure according to claim 1,
wherein the diffusion slope surface is sloped such that a more upstream side in a rotation direction of the rotor is located at a more outward position in the radial direction when seen from the axial direction of the rotor.

3. The stator-cooling structure according to claim 2,
wherein the diffusion slope surface is a curved surface having an arc shape and forming a protrusion inward in the radial direction.

4. The stator-cooling structure according to claim 3,
wherein the curved surface has a larger curvature at a more upstream side in the rotation direction of the rotor.

5. The stator-cooling structure according to claim 1,
wherein the diffusion slope surface comprises a front end surface that is directed outward in the radial direction.

6. The stator-cooling structure according to claim 1,
wherein a plurality of diffusion slope surfaces are provided throughout the entire outer circumferential part of the end surface plate.

7. The stator-cooling structure according to claim 6,
wherein the plurality of diffusion slope surfaces are arranged at an equal interval along an outer circumference of the end surface plate.

8. The stator-cooling structure according to claim 1,
wherein the diffusion slope surface is provided on a protrusion that protrudes outward in the radial direction from the outer circumferential part of the end surface plate.

9. The stator-cooling structure according to claim 1,
wherein the diffusion slope surface is provided on a groove part that is hollowed inward in the radial direction from the outer circumferential part of the end surface plate.

10. A rotary electric machine, comprising:
a stator; and
the stator-cooling structure according to claim 1.
